(19) United States
(12) Patent Application Publication
(10) Pub. No.: US 2019/0035618 A1
(43) Pub. Date: Jan. 31, 2019

(54) QUADRUPOLE MASS FILTER AND QUADRUPOLE TYPE MASS SPECTROMETRY DEVICE

(71) Applicant: SHIMADZU CORPORATION, Kyoto-shi, Kyoto (JP)

(72) Inventors: Hiroko UEDA, Kyoto-shi (JP); Shinji MIYAUCHI, Kyoto-shi (JP); Yoshihiro UENO, Kyoto-shi (JP)

(73) Assignee: Shimadzu Corporation, Kyoto-shi, Kyoto (JP)

(21) Appl. No.: 15/775,224

(22) PCT Filed: Nov. 11, 2015
(86) PCT No.: PCT/JP2015/081758

§ 371 Date: Oct. 15, 2018

(51) Int. Cl. H01J 49/42

(52) U.S. Cl. CPC H01J 49/4215

(57) ABSTRACT

A pre-electrode unit (32) placed in front of a main electrode unit (31) have a two-stage configuration. A front pre-electrode unit (32A) and rear pre-electrode unit (32B) are respectively supplied with radio-frequency voltages whose frequency is the same as that of a radio-frequency voltage applied to rod electrodes in the main electrode unit (31), and whose amplitude decreases in a stepwise manner toward the front side. Decreasing the amplitude of a radio-frequency voltage increases the ion acceptance. Therefore, by appropriately adjusting the amplitudes, the matching between the emittance of an incoming ion beam and the acceptance can be improved. The ion transmittance of the entire quadrupole mass filter (3) is significantly affected by the ion transmittance at the point of entry of the ion into the pre-electrode unit (32) as well as the ion transmittance at the point of entry of the ion from the pre-electrode unit (32) into the main electrode unit (31), rather than the ion transmittance within the pre-electrode unit (32). Therefore, the ion transmittance of the quadrupole mass filter (3) can be enhanced by improving those transmittances.

### TECHNICAL FIELD

The present invention relates to a quadrupole mass filter for selecting an ion having a specific mass-to-charge ratio m/z, and a quadrupole mass spectrometer using such a quadrupole mass filter as a mass separator. The quadrupole mass spectrometer in the present context includes not only a normal type of single quadrupole mass spectrometer using a quadrupole mass filter as the single mass separator, but also a triple quadrupole mass spectrometer, in which two quadrupole mass filters are provided to perform an MS/MS analysis, as well as a Q-TOF mass spectrometer, in which an ion selected by a quadrupole mass filter is dissociated, and the ions generated by the dissociation are separated and detected according to their mass-to-charge ratios by a time-of-flight mass separator.

### BACKGROUND ART

In a single quadrupole mass spectrometer, various ions generated from a sample are introduced into a quadrupole mass filter, which selectively allows only an ion having a specific mass-to-charge ratio to pass through. The ion which has passed through the filter is detected with a detector to acquire an intensity signal corresponding to the amount of ion.

In general, a quadrupole mass filter includes four rod electrodes arranged parallel to each other in such a manner as to surround an ion beam axis. Each of the four rod electrodes is supplied with a voltage produced by adding a direct-current voltage and a radio-frequency voltage (alternating voltage). The mass-to-charge ratio of an ion which is allowed to pass through the space surrounded by the four rod electrodes in the axial direction of the same space depends on the radio-frequency voltage and the direct-current voltage applied to those rod electrodes. Accordingly, by appropriately setting the radio-frequency voltage and the direct-current voltage according to the mass-to-charge ratio of the target ion which should be subjected to the measurement, it is possible to selectively allow the target ion to pass through and be detected. Additionally, by changing the radio-frequency voltage and the direct-current voltage applied to the rod electrodes within their respective predetermined ranges while maintaining a predetermined relationship between the two voltages, the mass-to-charge ratio of the ion passing through the quadrupole mass filter can be continuously changed over a predetermined scan range, and a mass spectrum can be created based on the signals obtained with the detector through this scan operation.

As described in Non-Patent Literature 1 or other documents, detailed analyses have conventionally been made concerning the behavior of an ion in a quadrupole electric field created within a space surrounded by the rod electrodes constituting a quadrupole mass filter by voltages applied to those rod electrodes, the operational conditions for the ion to pass through the filter in a stable manner, and other related matters.

The motion of an ion passing through an ideal quadrupole electric field created within a space surrounded by rod electrodes extending in a z-axis direction is expressed by the following equation called the Mathiu equations:

m(d²x/dt²)=−(2zex/r₀²)(U−V cos Ωt)

m(d²y/dt²)=+(2zey/r₀²)(U−V cos Ωt)

where m is the mass of the ion, r₀ is the radius of the inscribed circle of the rod electrodes, e is the charge quantity, U is the voltage value of the direct-current voltage, V is the amplitude value of the radio-frequency voltage, and Ω is the frequency of the radio-frequency voltage. Parameter z represents the position on the z axis, while x and y respectively represent the positions on the x and y axes which are both orthogonal to the z axis.

The condition for an ion to pass through the space surrounded by the four rod electrodes in a stable manner while being confined within the same space can be expressed by an area on a two-dimensional space formed by two mutually orthogonal axes which respectively indicate the following parameters a and q, which are obtained by solving the Mathiu equations mentioned earlier:

aₓ=−a_{y}=8eU/mr₀²Ω²

qₓ=−q_{y}=4eV/mr₀²Ω²

FIG. 8 is a stability diagram, which is often used for explaining the stability condition of the solution to the Mathiu equations. The roughly triangular area surrounded by the solid line in FIG. 8 is the stability area which becomes the stable solution to the aforementioned equations, while the outside area is the instability area where ions become dissipated. It should theoretically be possible to make an ion having a specific mass-to-charge ratio pass through in a stable manner by determining the voltages and other related conditions so that the ion is located within the stability area. However, in order to obtain a high level of mass-resolving power, it is necessary to determine the operational condition at a position close to the peak P of the stability area. Therefore, the operational condition is normally determined near the peak P, e.g. at point A, in order to maintain a high level of mass-resolving power while preventing the operational condition from entering the instability area even if it varies or fluctuates.

However, in an actual measurement by a quadrupole mass spectrometer, ions are generated outside the quadrupole mass filter and made to enter the space surrounded by the rod electrodes through an end of the same space. The electric field at the end portion, i.e. the fringe field, is weaker than the quadrupole electric field created within the inner area. Therefore, if the behavior of an ion entering the quadrupole mass filter under the effect of the electric field is represented by a line on the stability diagram, the line passes through the instability area before entering the stability area, as indicated by the broken-line arrow in FIG. 8. While ions are passing through the instability area indicated by reference sign “B” in FIG. 8, their motion is unstable, and some of the ions become dissipated and lost before entering the stable quadrupole electric field. This is a major cause of the decrease in the transmittance of the ions passing through the quadrupole mass filter.

To solve the previously described problem, many quadrupole mass spectrometers have the configuration in which quadrupole pre-rod electrodes are placed immediately before the main rod electrodes for selecting an ion according to the mass-to-charge ratio in the quadrupole mass filter. The pre-rod electrodes have the same diameter as the main rod electrodes and are shorter than the main rod electrodes. The same radio-frequency voltage as the one applied to the main rod electrodes is applied to the pre-rod electrodes (see Patent Literature 1 or 2, Non-Patent Literature 2, or other documents). The direct-current voltage for ion selection applied to the main rod electrodes is not applied to the pre-rod electrodes. Therefore, as described in Patent Literature 2, if the behavior of an ion which initially passes through the space surrounded by the pre-rod electrodes and subsequently enters the space surrounded by the main rod electrodes is represented by a line on the stability diagram, the line constantly passes through the stability area until it reaches the point A, as indicated by the broken-line arrow in FIG. 9. In this case, the ion does not pass through the instability area, and therefore, will be efficiently introduced into the space surrounded by the main rod electrodes. Therefore, the ion transmittance can be higher than in the case where the pre-rod electrodes are not present.

However, according to simulation calculations and related studies by the present inventors, a considerable portion of the ions which are about to enter the quadrupole mass filter will be wasted even when the quadrupole mass filter having the pre-rod electrodes is used as described earlier. There is still a significant room for the ion transmittance to be improved. In recent years, in the area of mass spectrometry, there is an increasing demand for an identification or quantitative determination of an extremely trace amount of component in a sample. To meet such a demand requires a further improvement in the detection sensitivity. For a quadrupole mass spectrometer including a quadrupole mass filter, it means that a further improvement in the ion transmittance of the quadrupole mass filter is extremely important.

### CITATION LIST

### Patent Literature

Patent Literature 1: U.S. Pat. No. 3,129,327 A

Patent Literature 2: JP 2005-259616 A

### Non Patent Literature

Non Patent Literature 1: Austin WE and two other authors, “CHAPTER VI—THE MASS FILTER: DESIGN AND PERFORMANCE”, Quadrupole Mass Spectrometry and its Applications, Elsevier, 1976

Non Patent Literature 2: Wilson M. Brubaker, “An Improved Quadrupole Mass Analyser”, Advances in Mass Spectrometry, Vol. 4, 1968, pp. 293-299

### SUMMARY OF INVENTION

### Technical Problem

The present invention has been developed to solve the previously described problem. Its objective is to provide a quadrupole mass filter which can improve the transmittance of an ion to be subjected to a measurement. Another objective of the present invention is to provide a quadrupole mass spectrometer in which such a quadrupole mass filter with a high level of ion transmittance is used to increase the amount of ion which eventually reaches the detector, and achieve a high level of detection sensitivity.

### Solution to Problem

In a conventional and common type of quadrupole mass filter, the pre-electrode unit placed in front of the main electrode unit consists of four short rod electrodes arranged around the central axis in a similar manner to the rod electrodes in the main electrode unit. Furthermore, the rod electrodes included in the pre-electrode unit are supplied with the same radio-frequency voltage as the one applied to the rod electrodes in the main electrode unit. The radio-frequency voltage applied to the rod electrodes in the main electrode unit is normally set so that an ion having a mass-to-charge ratio that should be allowed to pass through (i.e. that should be selected) can efficiently pass through, i.e. so that the amount of transmitted ion will be maximized (or practically, so that the intensity of the ion to be detected will be maximized). Therefore, applying the same radio-frequency voltage to the rod electrodes in the pre-electrode unit means that the ion having the mass-to-charge ratio that should be allowed to pass through can also efficiently pass through the rod electrodes in the pre-electrode unit.

However, the ion transmittance at the point in time where an ion enters the space surrounded by the rod electrodes in the pre-electrode unit as well as the ion transmittance at the point in time where the ion which has exited the rod electrodes in the pre-electrode unit enters the space surrounded by the rod electrodes in the main electrode unit both depend on the matching between the emittance of the incoming ion beam and the acceptance on the receiving side. If the degree of matching is low, a portion of the ions which are about to enter the space will be dissipated. Such a matching has not conventionally been considered as a factor for improving the overall ion transmittance; importance has been solely attached to the ion transmittance within the space surrounded by rod electrodes as described earlier.

However, through a repetition of simulation calculations and related studies under various conditions, the present inventors have gained the insight that what is important for improving the overall ion transmittance is the ion transmittance at the point in time where an ion enters the space surrounded by the rod electrodes in the pre-electrode unit as well as the ion transmittance at the point in time where the ion which has exited the rod electrodes in the pre-electrode unit enters the space surrounded by the rod electrodes in the main electrode unit, rather than the ion transmittance during the passage of the ion through the space surrounded by the rod electrodes in the pre-electrode unit which does not directly contribute to the selection of the ion.

As already explained, the ion transmittance at the incidence of an ion can be improved by improving the matching between the emittance of the incoming ion beam and the acceptance on the receiving side. Changing the emittance of the ion beam which enters the quadrupole mass filter is difficult since it requires a change in the configuration and structure of the entire mass spectrometer. Changing the ion acceptance in the main electrode unit is also difficult since it may possibly deteriorate the transmittance of the ion passing through the main electrode unit. Accordingly, the present inventors have studied the configuration and structure of the electrodes in the pre-electrode unit as well as the applied voltages and other related conditions. Consequently, it has been confirmed that it is possible to improve the matching mentioned earlier and enhance the overall ion transmittance by appropriately determining the aforementioned elements. Thus, the present invention has been conceived.

Thus, a quadrupole mass filter according to the present invention developed for solving the previously described problem includes:

a) a main electrode unit including a plurality of rod electrodes arranged in such a manner as to surround a central axis;

b) a pre-electrode unit placed in front of the main electrode unit along the central axis, the pre-electrode unit including a plurality of electrode sets separated from each other along the central axis, where each of the electrode sets includes a plurality of electrodes arranged in such a manner as to surround the central axis;

c) a first electrode supplier for applying voltages to the rod electrodes of the main electrode unit, respectively, where each of the voltages is generated by adding a direct-current voltage and a radio-frequency voltage and corresponds to the mass-to-charge ratio of an ion to be allowed to pass through; and

d) a second voltage supplier for applying radio-frequency voltages having the same frequency as the frequency of the radio-frequency voltage to the electrodes in the pre-electrode unit, where the amplitude of the radio-frequency voltages applied to the electrodes in the pre-electrode unit sequentially decreases at each electrode set in the direction from the main electrode unit toward the front side.

The quadrupole mass spectrometer according to the present invention developed for solving the previously described problem is characterized in that the quadrupole mass filter according to the present invention is used as at least one mass separator.

In the quadrupole mass filter according to the present invention, the pre-electrode unit includes a plurality of electrode sets arranged along the central axis, where each electrode set includes, for example, four short rod electrodes arranged around the central axis in a similar manner to the rod electrodes in the main electrode unit. The second voltage supplier applies, to the rod electrodes in each electrode set in the pre-electrode unit, a radio-frequency voltage having the same frequency as that of the radio-frequency voltage applied to the rod electrodes in the main electrode unit, where the amplitude of the former radio-frequency voltage is not the same as that of the radio-frequency voltage applied to the rod electrodes in the main electrode unit, but is made to decrease at each electrode set in the direction toward the front side. For example, if the pre-electrode unit includes two electrode sets arranged along the central axis, with each set composed of four short rod electrodes, a radio-frequency voltage whose amplitude is smaller than that of the radio-frequency voltage applied to the rod electrodes in the main electrode unit is applied to the rear set of electrodes, while a radio-frequency voltage whose amplitude is even smaller than that of the radio-frequency voltage applied to the rear set of electrodes is applied to the front set of electrodes.

Decreasing the amplitude of the radio-frequency voltage applied to the four rod electrodes surrounding the central axis increases the ion acceptance as well as increases the emittance of the ion beam exiting those rod electrodes after passing through them. In the quadrupole mass filter according to the present invention, the electrodes in the pre-electrode unit are divided into segments arranged along the central axis, i.e. the ion beam axis, and the amplitude of the radio-frequency voltages applied to the segments of electrode is made to increase in a stepwise manner in the direction from the ion-entrance side toward the main electrode unit. Such a configuration decreases the difference between the emittance of the ion beam and the acceptance on the receiving side at a point where ions enter the space surrounded by one set of electrodes, whereby the matching between the emittance and the acceptance is improved. Consequently, the ion transmittance at the point where ions coming from an ion source, ion transport optical system or the like in the previous stage enter the pre-electrode unit, as well as the ion transmittance at the point where the ions exiting the pre-electrode unit enter the main electrode unit, will be higher than in a conventional device, so that the overall ion transmittance of the quadrupole mass filter will also be improved.

### Advantageous Effects of Invention

As described so far, with the quadrupole mass filter according to the present invention, it is possible to improve the ion transmittance for an ion that should be selected, and send a larger amount of ion to the subsequent stages.

With the quadrupole mass spectrometer according to the present invention, it is possible to make a larger amount of target ion originating from a sample to reach the detector, or dissociate a larger amount of target ion in a collision cell or the like and perform a mass spectrometric analysis on the product ions generated by the dissociation. Therefore, the detection sensitivity for the target ion originating from the sample will be improved, which is advantageous for the identification, quantitative determination or structural analysis of a trace amount of component.

### BRIEF DESCRIPTION OF DRAWINGS

FIG. 1 is a schematic configuration diagram of one embodiment of a mass spectrometer using a quadrupole mass filter according to the present invention.

FIG. 2 is a configuration diagram of a quadrupole mass filter and a voltage supplier in the mass spectrometer according to the present embodiment.

FIG. 3 is a simulation model for calculating a relative ion-transmission quantity in a quadrupole mass filter.

FIG. 4 is a graph showing the result of the simulation of the relative ion-transmission quantity of the entire quadrupole mass filter for an ion with a mass-to-charge ratio of m/z=500.

FIGS. 5A and 5B are graphs showing the results of the simulation of the relative ion-transmission quantity of the entire quadrupole mass filter for different values of the length L₁ of the rod electrodes in the front pre-electrode unit.

FIGS. 6A to 6F are graphs showing the results of the simulation of the relative ion-transmission quantity of the entire quadrupole mass filter for various values of the length L₂ of the rod electrodes in the rear pre-electrode unit.

FIGS. 7A to 7C are graphs showing the results of the simulation of the relative ion-transmission quantity of the entire quadrupole mass filter for ions with different mass-to-charge ratios.

FIG. 8 is a stability diagram showing the motion condition of an ion passing through a quadrupole mass filter in which no pre-rod electrode is provided.

FIG. 9 is a stability diagram showing the motion condition of an ion passing through a quadrupole mass filter in which pre-rod electrodes are provided.

### DESCRIPTION OF EMBODIMENTS

One embodiment of a mass spectrometer using a quadrupole mass filter according to the present invention is hereinafter described with reference to the attached drawings.

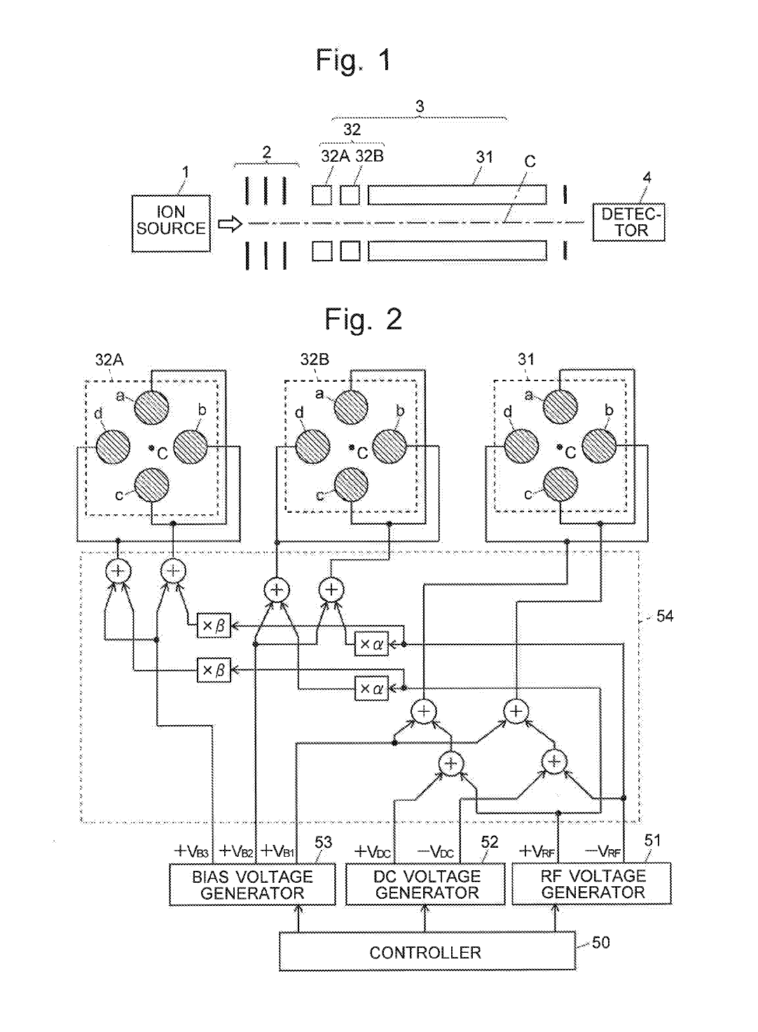

FIG. 1 is a schematic configuration diagram of a single-type quadrupole mass spectrometer which is the present embodiment. FIG. 2 is a configuration diagram of a quadrupole mass filter and a voltage supplier in the quadrupole mass spectrometer according to the present embodiment.

The quadrupole mass spectrometer according to the present embodiment includes an ion source 1, ion lens 2, quadrupole mass filter 3 and detector 4, all of which are contained in a vacuum chamber (not shown). For example, the ion source 1 ionizes sample components in a sample gas by electron ionization. Ions generated in the ion source 1 and extracted in the direction indicated by the white arrow in FIG. 1 are converged by the ion lens 2 and introduced into the quadrupole mass filter 3. The quadrupole mass filter 3 includes a main electrode unit 31 composed of four rod electrodes (as will be described later) and a pre-electrode unit 32 placed in front of the main electrode unit 31. The pre-electrode unit 32 has a two-stage structure including a front pre-electrode unit 32A and a rear pre-electrode unit 32B.

As will be detailed later, among the ions introduced into the longitudinally extending space in the quadrupole mass filter 3 along the ion beam axis C, only an ion having a specific mass-to-charge ratio is allowed to pass through the filter while oscillating within a space near the ion beam axis C due to the effect of an electric field created by a radio-frequency voltage and direct-current voltage applied to the rod electrodes of the quadrupole mass filter 3, whereas the other ions become dissipated halfway. The ion which has passed through the quadrupole mass filter 3 reaches the detector 4. The detector 4 produces a detection signal corresponding to the amount of ion which has reached the detector 4. The signal is sent to a data processing unit (not shown). When the radio-frequency voltage and the direct-current voltage applied to the rod electrodes of the quadrupole mass filter 3 are individually changed while maintaining a predetermined relationship, the mass-to-charge ratio of the ion which is allowed to pass through the quadrupole mass filter 3 also changes. Accordingly, by continuously changing the radio-frequency voltage and the direct-current voltage over their respective predetermined scan ranges, the mass-to-charge ratio of the ion which can reach the detector 4 can be continuously changed within a predetermined range. Based on the detection signals obtained through such an operation, a mass spectrum which shows the relationship between the mass-to-charge ratio and ion intensity can be created.

A configuration and operation of the quadrupole mass filter 3 in the mass spectrometer according to the present embodiment is hereinafter described in detail with reference to FIG. 2.

In FIG. 2, the front pre-electrode unit 32A, rear pre-electrode unit 32B and main electrode unit 31 are each illustrated by a cross sectional view at an orthogonal plane to the ion beam axis C. The front pre-electrode unit 32A, rear pre-electrode unit 32B and main electrode unit 31 each include four cylindrical rod electrodes (a, b, c and d) which have a circular cross section and are arranged parallel to the ion beam axis C in such a manner as to surround the same axis C. Those electrode units are identical in terms of the diameter of the rod electrodes as well as the radius r₀ of the inscribed circle of the rod electrodes centered at the central axis C. On the other hand, those units vary in the length of the rod electrodes along the ion beam axis C; the rod electrodes in the main electrode unit 31 are much longer than the rod electrodes in the front pre-electrode unit 32A as well as those of the rear pre-electrode unit 32B. Hereinafter, the length of the rod electrodes in the front pre-electrode unit 32A is denoted by L₁, and that of the rod electrodes in the rear pre-electrode unit 32B is denoted by L₂.

The total of 12 rod electrodes included in the front pre-electrode unit 32A, rear pre-electrode unit 32B and main electrode unit 31 are respectively supplied with predetermined voltages from a voltage supply section which includes a radio-frequency voltage generator 51, direct-current voltage generator 52, bias voltage generator 53 and voltage synthesizer 54.

A more detailed description is as follows: According to an instruction from a controller 50, the radio-frequency voltage generator 51 generates radio-frequency voltages +V_{RF} and −V_{RF} corresponding to the mass-to-charge ratio of the ion to be selected, where the two voltages have the same amplitude and opposite phases. Meanwhile, according to an instruction from a controller 50, the direct-current voltage generator 52 generates direct-current voltages +V_{DC} and −V_{DC} corresponding to the mass-to-charge ratio of the ion to be selected, where the two voltages have the same absolute value of the voltage and opposite polarities. The bias voltage generator 53 generates predetermined direct-current bias voltages V_{B1}, V_{B2} and V_{B3} so as to generate an appropriate potential difference relative to the electrode or ion optical system located in the previous or subsequent stage to accelerate or decelerate ions. The voltage synthesizer 54 includes a plurality of adders each of which adds voltages and a plurality of amplifiers each of which amplifies (actually, decreases the amplitude of) a voltage. In this voltage synthesizer 54, the normal-phase radio-frequency voltage +V_{RF} and the positive direct-current voltage +V_{DC} are added together, while the reverse-phase radio-frequency voltage −V_{RF} and the negative direct-current voltage −V_{DC} are added together. Furthermore, the direct-current bias voltage V_{B1} is added to each of the ±(V_{DC}+V_{RF}), and the resultant voltages are applied to the rod electrodes 31-a to 31-d in the main electrode unit 31. In this respect, the present embodiment is similar to a conventional and common type of quadrupole mass filter. The adders for adding the voltages as well as the voltage generators 51 and 52 correspond to the first voltage supplier in the present invention.

In the voltage synthesizer 54, the normal-phase radio-frequency voltage +V_{RF} and the reverse-phase radio-frequency voltage −V_{RF} are each multiplied by a (where 0<α<1) and added to the direct-current bias voltage V_{B2}. The resultant voltages are applied to the rod electrodes 32B-a to 32B-d in the rear pre-electrode unit 32B. That is to say, a voltage of +αV_{RF}+V_{B2} is applied to two rod electrodes 32B-b and 32B-d in the rear pre-electrode unit 32B, while a voltage of −αV_{RF}+V_{B2} is applied to the other two rod electrodes 32B-a and 32B-c. Additionally, the normal-phase radio-frequency voltage +V_{RF} and the reverse-phase radio-frequency voltage −V_{RF} are each multiplied by β (where 0<β<α<1) and added to the direct-current bias voltage V_{B3}. The resultant voltages are applied to the rod electrodes 32A-a to 32A-d in the front pre-electrode unit 32A. That is to say, a voltage of +βV_{RF}+V_{B3} is applied to two rod electrodes 32A-b and 32A-d, while a voltage of −βV_{RF}+V_{B3} is applied to the other two rod electrodes 32A-a and 32A-c. The adders for adding the voltages, the amplifiers for adjusting the amplitude values as well as the voltage generators 51 and 52 correspond to the second voltage supplier in the present invention.

In other words, the radio-frequency voltage applied to the rod electrodes 32B-a to 32B-d in the rear pre-electrode unit 32B has the same frequency as, and a smaller amplitude than, the radio-frequency voltage applied to the rod electrodes 31-a to 31-d in the main electrode unit 31, while the radio-frequency voltage applied to the rod electrodes 32A-a to 32A-d in the front pre-electrode unit 32A has the same frequency as, and an even smaller amplitude than, the radio-frequency voltage applied to the rod electrodes 32B-a to 32B-d in the rear pre-electrode unit 32B.

By the voltages applied in the previously described manner, quadrupole radio-frequency electric fields are respectively created in the front pre-electrode unit 32A, rear pre-electrode unit 32B and main electrode unit 31. The closer to the ion source 1 the electric field is, the weaker its strength is. The front pre-electrode unit 32A and the rear pre-electrode unit 32B basically do not have the function of separating ions according to their mass-to-charge ratios, since the direct-current voltage generated by the direct-current voltage generator 52 is not applied to the rod electrodes in the front pre-electrode unit 32A and the rear pre-electrode unit 32B.

The method of a simulation calculation carried out for studying the relative ion-transmission quantity in the quadrupole mass filter 3 is hereinafter described along with the obtained results.

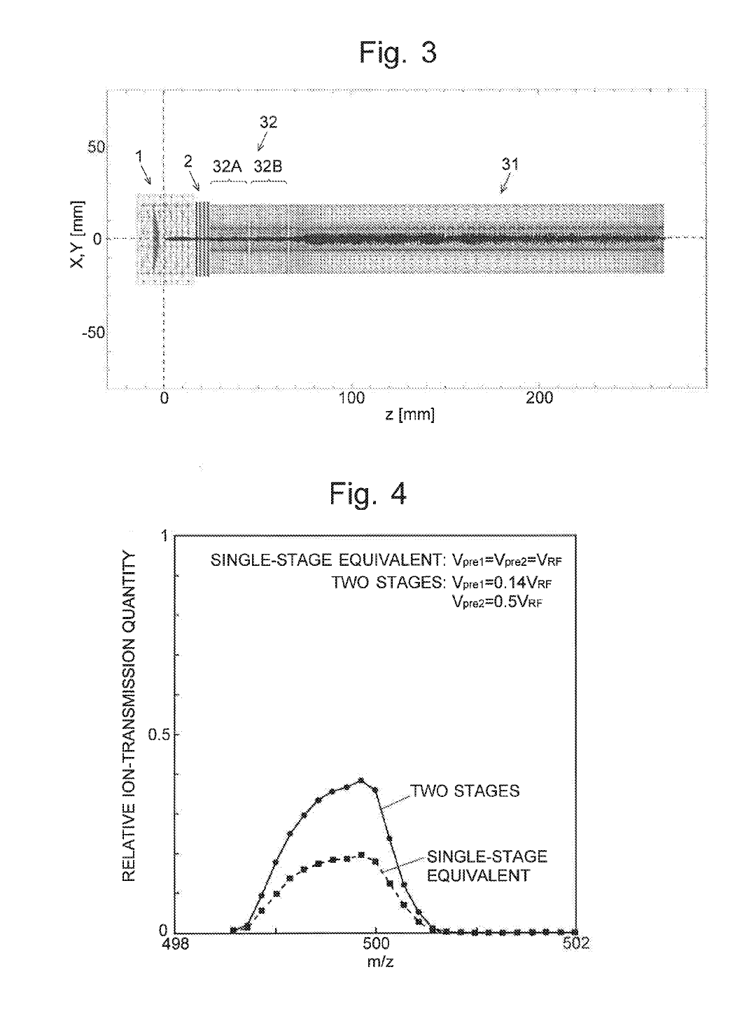

FIG. 3 is a diagram showing a device model used for the simulation calculation. The sizes and arrangement of the ion source 1, ion lens 2 and quadrupole mass filter 3 were set as shown in FIG. 3. The trajectories of ions departing from a coordinate position of (x, y, z)=(0, 0, 0) in FIG. 3 were calculated, and the relative transmission quantity of the ions which could pass through the quadrupole mass filter 3 was computed.

FIG. 4 is a graph showing the result of the simulation of the relative ion-transmission quantity for an ion with m/z=500. In the drawings, the graph labeled “single-stage equivalent” is the case where both the radio-frequency voltage applied to the front pre-electrode unit 32A and the radio-frequency voltage applied to the rear pre-electrode unit 32B were set to be equal to the radio-frequency voltage applied to the main electrode unit 31 (i.e. Vₚᵣₑ₁=Vₚᵣₑ₂=V_{RF}). Under this condition, the pre-electrode unit, despite its two-stage configuration, can be considered as substantially identical to a conventional single-stage configuration, and therefore, the entire system is equivalent to a conventional quadrupole mass filter with a pre-electrode unit. The graph labeled “two stage” in the drawings corresponds to the quadrupole mass filter 3 in the previously described embodiment. In the present case, the amplitude of the radio-frequency voltage applied to the front pre-electrode unit 32A is 0.14 times the amplitude of the radio-frequency voltage applied to the main electrode unit 31 (i.e. β=0.14 in FIG. 2), while the amplitude of the radio-frequency voltage applied to the rear pre-electrode unit 32B is 0.5 times the amplitude of the radio-frequency voltage applied to the main electrode unit 31 (i.e. α=0.5 in FIG. 2). As is evident from FIG. 4, the relative ion-transmission quantity of the quadrupole mass filter 3 in the previous embodiment is approximately two times the relative ion-transmission quantity of the conventional quadrupole mass filter. This means that the amount of ion reaching the detector 4 is doubled, and the detection sensitivity is improved accordingly.

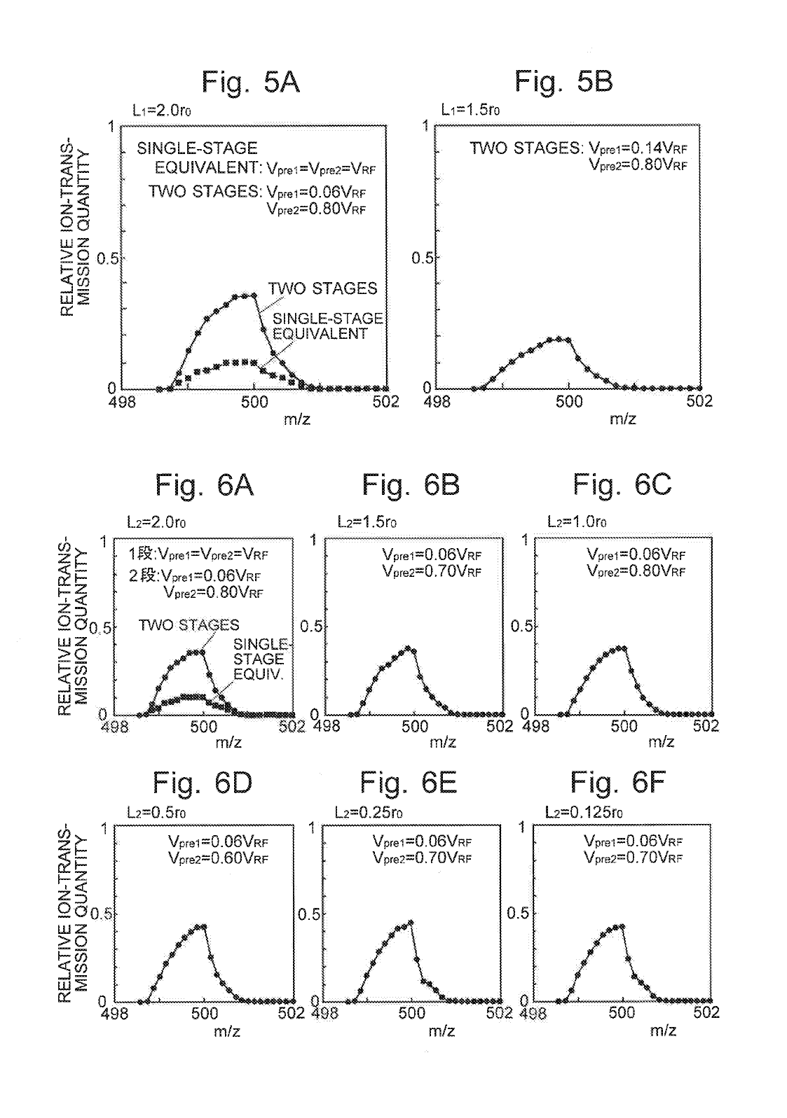

FIGS. 5A and 5B are graphs showing the results of the simulation of the relative ion-transmission quantity for different values of the length L₁ of the rod electrodes 32A-a to 32A-d in the front pre-electrode unit 32A. Specifically, FIG. 5A is the result obtained when L₁=2.0 r₀, and FIG. 5B is the result obtained when L₁=1.5 r₀. As noted earlier, r₀ is the radius of the inscribed circle of the rod electrodes.

FIGS. 6A to 6F are graphs showing the results of the simulation of the relative ion-transmission quantity for various values of the length L₂ of the rod electrodes 32B-a to 32B-d in the rear pre-electrode unit 32B. Specifically, FIGS. 6A to 6F respectively shows the results obtained when L₂=2.0 r₀, 1.5 r₀, 1.0 r₀, 0.5 r₀, 0.25 r₀, and 0.125 r₀. It should be noted that the amplitude value of the radio-frequency voltage applied to the rod electrodes of the front pre-electrode unit 32A and that of the radio-frequency voltage applied to the rear pre-electrode unit 32B, i.e. the values of α and β, are not always the same in all cases since those values are adjusted for each case so as to maximize the ion-transmission quantity.

FIGS. 5A and 5B demonstrate that, in the case where the length L₁ of the rod electrodes in the front pre-electrode unit 32A was set to 1.5 r₀, the relative ion-transmission quantity was as low as approximately one half of the quantity in the case where the length L₁ was set to 2.0 r₀. Accordingly, it is possible to consider that the length L₁ of the rod electrode in the front pre-electrode unit 32A should be set to approximately 2.0 r₀.

On the other hand, no noticeable change in relative ion-transmission quantity occurred with the change in the length L₂ of the rod electrodes in the rear pre-electrode unit 32B within a range from 2.0 r₀ to 0.125 r₀. Accordingly, it is possible to consider that the relative ion-transmission quantity is not significantly dependent on the length L₂ of the rod electrodes in the rear pre-electrode unit 32B, so that this length L₂ may be selected as needed within a range from 2.0 r₀ to 0.125 r₀.

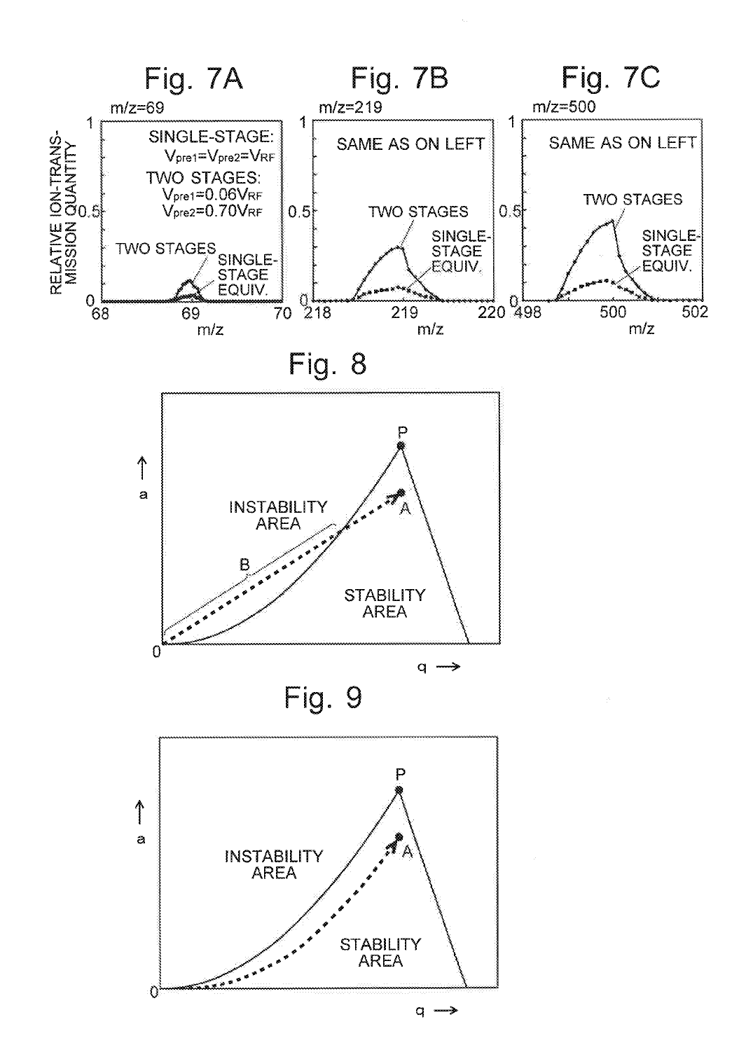

FIGS. 7A to 7C are graphs showing the results of the simulation of the relative ion-transmission quantity for three ions with different mass-to-charge ratios of m/z=68, 219 and 500. FIGS. 7A to 7C demonstrate that the quadrupole mass filter in the present embodiment yielded a sufficient increase in relative ion-transmission quantity at any of those mass-to-charge ratios as compared to the conventional quadrupole mass filter. Accordingly, it is possible to consider that the quadrupole mass filter according to the present embodiment can more efficiently allow the passage of an ion than the conventional quadrupole mass filter, regardless of the mass-to-charge ratio of the ion to be subjected to the measurement, so that a larger amount of ion can reach the detector 4, and a high detection sensitivity can be achieved.

The radius of the pseudopotential in the quadrupole radio-frequency electric field increases with a decrease in the amplitude of the radio-frequency voltage applied to the rod electrodes. In other words, decreasing the amplitude of the radio-frequency voltage increases the ion acceptance. Furthermore, the increase in the radius of the pseudopotential leads to an increase in the emittance of the ion beam exiting the quadrupole radio-frequency electric field. Based on the fact that the ion acceptance and ion emittance can be adjusted in this manner through the amplitude of the radio-frequency voltage, the values of α and β, which were α=0.5 and β=0.14 in the simulation example shown in FIG. 4, can be appropriately set according to the emittance of the incoming ion beam through the ion lens 2 and the ion acceptance at the main electrode unit 31 to improve the matching between the emittance and the acceptance.

In the examples shown in FIGS. 4 to 7C, the values of α and β were adjusted so that the ion-transmission quantity will be nearly maximized. A simulation-based study has confirmed that the relative ion-transmission quantity will be higher than in the case of the conventional quadrupole mass filter if 0.4≤α<1 and 0.07≤β<1 (where α<β).

As opposed to the embodiment shown in FIG. 1 in which the pre-electrode unit 32 has a two-stage configuration, a configuration with three or more stages may also be adopted. Even in that case, the amplitude of the radio-frequency voltages applied to the rod electrodes should be decreased in a stepwise manner in the direction from the main electrode unit 31 toward the ion source 1.

Naturally, the quadrupole mass filter having the previously described configuration can also be used as the front quadrupole mass filter and the rear quadrupole mass filter in a triple quadrupole mass spectrometer, or as the quadrupole mass filter in a Q-TOF mass spectrometer.

In FIG. 2, for ease of understanding, the voltage synthesizer 54 including the adders and amplifiers is used to generate voltages to be applied to the rod electrodes. It is evident that the circuit configuration for generating such a system of voltages is not limited to the previously described one. For example, it is possible to generate a radio-frequency voltage waveform in the form of digital data and perform the adding and multiplying operations on the digital values. The obtained digital values can be subsequently converted into an analogue waveform corresponding to the radio-frequency voltage, which can be applied through a drive circuit to the rod electrodes. Needless to say, other forms of circuit configurations can also be easily conceived.

It should also be noted that the previous embodiment is a mere example of the present invention, and any change, modification or addition appropriately made within the spirit of the present invention will naturally fall within the scope of claims of the present application.

### REFERENCE SIGNS LIST

1 . . . Ion Source
2 . . . Ion Lens
3 . . . Quadrupole Mass Filter
31 . . . Main Electrode Unit
32 . . . Pre-Electrode Unit
32A . . . Front Pre-Electrode Unit
32B . . . Rear Pre-Electrode Unit
4 . . . Detector
50 . . . Controller
51 . . . Radio-Frequency Voltage Generator
52 . . . Direct-Current Voltage Generator
53 . . . Bias Voltage Generator
54 . . . Voltage Synthesizer
C . . . Ion Beam Axis

1. A quadrupole mass filter comprising:
a) a main electrode unit including a plurality of rod electrodes arranged in such a manner as to surround a central axis;
b) a pre-electrode unit placed in front of the main electrode unit along the central axis, the pre-electrode unit including a plurality of electrode sets separated from each other along the central axis, where each of the electrode sets includes a plurality of electrodes arranged in such a manner as to surround the central axis;
c) a first electrode supplier for applying voltages to the rod electrodes of the main electrode unit, respectively, where each of the voltages is generated by adding a direct-current voltage and a radio-frequency voltage and corresponds to the mass-to-charge ratio of an ion to be allowed to pass through; and
d) a second voltage supplier for applying radio-frequency voltages having a same frequency as a frequency of the radio-frequency voltage to the electrodes in the pre-electrode unit, where an amplitude of the radio-frequency voltages applied to the electrodes in the pre-electrode unit sequentially decreases at each electrode set in a direction from the main electrode unit toward a front side.

2. A quadrupole mass spectrometer, wherein the quadrupole mass filter according to claim 1 is used as a mass separator.
